(19) United States
(12) Patent Application Publication
(10) Pub. No.: US 2022/0222954 A1
(43) Pub. Date: Jul. 14, 2022

(54) IDENTITY VERIFICATION OR IDENTIFICATION METHOD USING HANDWRITTEN SIGNATURES AFFIXED TO A DIGITAL SENSOR

(71) Applicant: INSTITUT MINES TELECOM, Palaiseau (FR)

(72) Inventors: Nesma HOUMANI, Melun (FR); Sonia GARCIA-SALICETTI, Paris (FR)

(21) Appl. No.: 17/440,958

(22) PCT Filed: Mar. 10, 2020
(86) PCT No.: PCT/EP2020/056304

§ 371 Date: Sep. 20, 2021

(30) Foreign Application Priority Data
Mar. 21, 2019 (FR) 1902945

(51) Int. Cl. G06V 30/32; G06V 30/244; G06V 10/82; G06V 10/84

(52) U.S. Cl. CPC G06V 30/36; G06V 30/2455; G06V 30/347; G06V 10/85; G06V 10/82

(57) ABSTRACT

A method for identifying or for verifying the identity of a user, using a plurality, of previously acquired reference signature vectors, a handwritten signature of the user and at least one additional item of handwritten information linked to the user that arc affixed beforehand to an in particular mobile digital sensor, in which method: a) said handwritten signature of the user and said at least one additional item of information are fused in order to generate at least one test signature vector, b) said at least one test signature vector is compared with a plurality of said reference signature vectors, and c) a likelihood score is generated on the basis at least of this comparison in order to identify or to verify the identity of the user.

The present invention relates to a method for verifying the identity or identifying a user, using handwritten signatures inscribed beforehand on a digital sensor.

### TECHNICAL FIELD

The explosion of services provided on-line via personal accounts and mobile digital devices has fostered the emergence of identity crime, which relies on identity theft in many contexts. In parallel, new sensors have appeared that are characterized by touch screens that are sensitive to a finger or stylus, such as tablets or smartphones. These sensors are widely used at the current time and are the origin of new security needs.

Handwritten signatures, one of the few biometrics that the user is able to modify, have long been in routine everyday use by the general public. In today's society, a signature on a paper document is a sign of a legal and moral commitment. In contrast, on-line signatures, i.e. signatures acquired on a digital platform, are not in routine use by the general public, because they are considered to be an unreliable biometric compared to other more widely used biometrics such as fingerprints or iris scans. Specifically, in biometric identity verification, the enrolment of an individual's reference data is a critical phase on which the performance of the verification system will subsequently depend. Nevertheless, more and more applications on mobile platforms allow an individual to inscribe his signature electronically as a way of obtaining his consent and of authenticating him in the event of a dispute. The articles by S. Garcia-Salicetti et al “A Novel Criterion for Writer Enrolment based on a Time-Normalized Signature Sample Entropy Measure”, EURASIP Journal on Advances in Signal Processing, Vol. 2009, by N. Houmani et al “BioSecure Signature Evaluation Campaign (BSEC'2009): Evaluating Online Signature Algorithms Depending on the Quality of Signatures”, Pattern Recognition, 45(3): 993-1003, 2011, and by N. Houmani and S. Garcia-Salicetti “Quality criteria for on-line handwritten signature”, in “Signal and Image Processing for Biometrics”, Lecture Notes in Electrical Engineering, Eds: J. Scharcanski, H. Proenca and E. Du; Publisher Springer, 292: 255-283, 2014, show that the acquisition of signatures under mobile conditions and/or remotely degrades the performance of identity verification systems. By “mobile conditions” what is meant is cases where the sensor is not fastened to a holder, the user being stood or seated for example with the sensor held in his hand and/or the sensor being placed on a table or pressed against a wall or door.

The acquisition conditions, especially whether a stylus or finger is used, the type of stylus, the size of the screen, the capture technology also have an impact on performance. This is slowing down the large-scale adoption of signatures as biometrics on mobile digital platforms.

### Prior Art

Various strategies for improving the performance of identity verification systems based on handwritten signatures are known, such strategies including: use of high-performance sensors, graphics tablets for example, especially of the Wacom brand; the acquisition of signatures under controlled conditions; the extraction of a plurality of parameters of the dynamics, such as pressure, speed, tilt angles, acceleration, etc.; or the selection of reference signatures to control the intra-class variability of the individual.

U.S. Pat. No. 6,349,148 describes a method and device intended for authentication of a signature, in which a hidden Markov model (HMM) is trained using training data obtained from authentic signatures and is then applied to the data to be authenticated.

Patent application FR 2 893 733 describes a method for authenticating a user within an IT system that may comprise at least two devices for acquiring sequential data specific to the signatures of users, these acquiring devices having different characteristics. The method uses normalized values of a set of parameters describing the signature, these values being obtained from said sequential data, and uses a statistical HMM trained using normalized reference values to determine an authentication score representative of a possible correspondence between the user to be authenticated and a known user.

Patent applications CN 106934362 and US 2018/0247108 relate to methods for authenticating handwritten signatures using an analysis of separate segments of the signatures to determine characteristics describing the production of these signatures.

Patent application CN 106326701 describes a method and device intended for authentication of a handwritten signature, the method collecting and analyzing the pen strokes of a user's signature in order to determine a specific writing habit of the user, the analysis being based on aspects such as horizontal, perpendicular and rotational angles, or intervals between the pen strokes.

These strategies have been applied to on-line handwritten signatures acquired on pen tablets, generally under controlled conditions, i.e. when the tablet is not mobile.

Other strategies are employed to keep the identity of people secure on-line, these being based on the generation of digital keys in addition to a handwritten signature. These methods are more complex.

### SUMMARY OF THE INVENTION

Therefore, there is a need to use a handwritten signature to increase digital-identity security on-line, especially during the phase of enrolling a user on various digital platforms under mobility conditions and during phases of verifying the identity or identifying the user.

The aim of the present invention is precisely to meet this need.

### SUMMARY OF THE INVENTION

One subject of the present invention is thus a method for identifying or verifying the identity of a user, using a plurality of previously acquired reference signature vectors, a handwritten signature of the user and at least one complementary handwritten piece of information related to the user, the handwritten signature of the user and the at least one complementary handwritten piece of information related to the user having been inscribed beforehand on a digital sensor, especially a mobile digital sensor, in which method:

a) said handwritten signature of the user and said at least one complementary piece of information are merged to generate at least one test signature vector,

b) said at least one test signature vector is compared to a plurality of said reference signature vectors, and

c) on the basis at least of this comparison, a likelihood score is generated in order to identify or verify the identity of the user.

The invention allows the performance of identity verification systems using the biometrics of an on-line handwritten signature to be improved by way of a enrolment procedure that increases the security of an individual's signature and thereby makes him less vulnerable to fraud, in particular in a mobile situation.

The invention, which is based on the fact that his signature is one of the rare biometrics that the user is able to enrich with information, without losing the identity-related aspect of the gesture, exploits the addition of handwritten information specific to the individual during enrolment to increase security.

The invention uses, to enrich the signature, complementary pieces of information handwritten that the user is used to inscribing on various administrative documents when making legal and moral commitments, such as his last name and first name, the date and place, or his date and place of birth. These pieces of information contain additional information on the identity of the individual, which complements his signature.

Since the invention focuses on enrichment of the information of the signal itself and does not employ a complementary modality, complexity is not increased as in known methods using digital keys.

The increase in security, even in a mobile situation, thus allows more widespread use of a behavioral digital identity via handwritten signature on-line, without constraining users during the acquisition of their signature via the sensor used and the acquisition conditions, such as whether mobile or not, the use of a stylus or finger, or the posture of the user.

Implementation of the method according to the invention costs less, because the sensors required to acquire the signature are widely deployed at the present time, especially in smartphones and tablets, and it is less resource-intensive to process and store the data than is the case with other biometrics, such as iris scans or fingerprints.

By virtue of the invention, the security of the signature is increased, whatever the type of signature in question, by enriching it so as to move it from the “high-risk” category to the “low-risk” category, even when it is a question of populations that may be said to be “problematic” as regards this behavioral biometry, such populations being characterized by handwritten signatures that are simple and/or highly variable, and therefore very easy to imitate.

The verification of the identity of a user corresponds to determining whether the claimed identity is indeed correct, and the identification of a user corresponds to determining whether the user belongs to a group of known users, for example tied to an on-line service or sales site. These actions may be grouped under the general term of authentication.

Signature Vectors

The complementary pieces of information related to the users are preferably the initials, last name, first name, date of birth, and/or place of birth of the user. In one variant and in combination, the complementary pieces of information are the current date and the place where the signature was inscribed on the sensor.

When seeking to identify a user, especially the user of an on-line site, the reference signature vectors advantageously correspond to the signatures of various users, these signatures having been inscribed beforehand on a digital sensor and each having been merged with at least one complementary piece of information related to the corresponding user.

When seeking to verify the identity of a user, the reference signature vectors may correspond to various signatures inscribed beforehand by said user on a digital sensor, each signature having been merged with at least one complementary piece of information related to the user.

During the enrolment of the various signatures inscribed beforehand by said user on a digital sensor, a trusted third party, for example a bank employee or a notary, may guarantee the identity of the user.

The same type of complementary information may be used to generate the reference signature vectors of a given user.

Preferably, the handwritten signatures are merged with the complementary pieces of information by concatenation to generate the signature vectors. The data acquired via the digital sensor being considered to be sequential data, or time series, the concatenation may be achieved via juxtaposition of these data in a row vector. Thus, the signature vector is advantageously a row vector of size equal to the sum of the sizes of the various data.

The signature vectors advantageously correspond to handwritten signatures of a user merged with his initials, and/or with his last name and first name, and/or with his date of birth, and/or with his place of birth.

A computation of an elastic distance between the test signature vector and the reference signature vectors may be used for their comparison.

The test signature vector may be associated with a score, especially a so-called dissimilarity score, which corresponds to the average of the N computed distances between said test vector and N reference signature vectors. In one variant, the score corresponds to the minimum of these N distances.

Trained Module

In one variant embodiment of the invention, a module may be trained beforehand to learn said plurality of previously acquired reference signature vectors, said module being then trained to compare said test signature vector to a plurality of said reference signature vectors in order to generate the likelihood score.

By “trained module” what must be understand is a model with associated learning and training algorithms that analyze the data, and that are used for the purpose of classification or regression analysis, or for modeling or characterizing information.

The trained module may comprise one or more neural networks, and/or one or more decision trees, for example classification and regression trees (CARTs), and/or one or more classifiers, a support vector machine (SVM) for example.

The trained module preferably uses a hidden Markov model. This model is very robust.

As a variant, the trained module uses models chosen from the following models: Gaussian mixture models, models of elastic distance employing parameter learning, fuzzy methods, Bayesian networks, hidden control fields or Markov random fields, k-nearest neighbors methods, grouping techniques, ensemble methods, aggregating or bagging techniques, linear discriminant analysis, kernel discriminant analysis, or genetic algorithms, this list being non-exhaustive.

One or more parameters may be chosen for the trained module, for example the number of states of hidden Markov models, the number of layers of neural networks, the number of component densities for statistical models, the type of kernel functions in support vector machines.

A reference identity may be formed for the user from the reference signature vectors by learning a statistical model, especially by means of an expectation-maximization algorithm, especially comprising a number of states that is determined depending on the length of said reference signature vectors, each state especially being modeled by one or more Gaussian densities, and preferably by four Gaussian densities.

This allows the digital identity of a user to be enrolled, and a set of user signatures to be modelled statistically, for future comparison.

A handwritten signature of the user and at least one complementary piece of information are advantageously merged to generate a test signature vector, which is transmitted to the trained module to be compared with the reference identity of said user in order to generate a likelihood score of the identity of the user.

Likelihood Score

The likelihood score may take the form of a probability.

The score may take the form of a numerical value, for example to verify the identity of a user, a discrete value for example, especially comprised between 0 and 10 or between 0 and 1.

In the case of a probability or a numerical value, preferably, the higher the value, the higher the chance that it is indeed the claimed user.

As a variant, especially in the case where a computation of elastic distance is used for the comparison, the score may rather indicate the degree of dissimilarity between the test signature vector and the reference signature vectors. Thus, the higher the value, the lower the chance that it is indeed the claimed user.

As a variant, the score takes the form of a letter.

The likelihood score may be compared to one or more predefined thresholds in order to make a decision as to the identity of the user or as to the validity of his identification.

In the case of a score taking the form of a discrete value comprised between 0 and 1, the predefined threshold may be comprised between 0.65 and 0.9.

The predefined threshold advantageously depends on the envisioned application. Such a threshold may be learnt from a development database containing authentic signature vectors and imitations, and then adjusted depending on the security level required by the application. In the case where a very high security level is required, the predefined threshold may be set to a value comprised between 0.8 and 0.9. In the case where the required security level is lower, the predefined threshold may be set to 0.65. For a low-security use (threshold set to 0.65) and comparison of authentic signatures to imitations of the dynamics of these signatures, the identity verification system allows an equal error rate (EER) of 8% to be obtained on a touchpad.

The likelihood score may be transmitted by any suitable means, it for example being displayed on a screen of an electronic system, printed or transmitted via voice synthesis.

Said likelihood score may be used as a value input into another program and/or may be combined with other information, for example the age and sex of the individual.

All the steps of the method according to the invention are advantageously implemented automatically by a computer.

### Digital Sensor

The digital sensor is preferably mobile. The digital sensor may comprise a touch screen, which is sensitive to a finger or stylus, and which is used to inscribe the signatures and the complementary pieces of information.

The digital sensor may be a smartphone, a graphics tablet or digitizer connected to a computing unit, or a personal digital assistant (PDA), or a touchpad, or an interactive whiteboard.

The digital sensor used to acquire the reference signature vectors beforehand may be different from that used to verify the identity of the user or identify him.

Steps a) to c) of the method according to the invention may be carried out by the digital sensor. As a variant and preferably, at least one of the steps may be performed by a server that exchanges data with the digital sensor.

The digital sensor preferably transmits the handwritten signatures and the complementary pieces of information to a database for them to be stored in order to be used for the comparison, especially using a secure protocol, especially the SFTP protocol.

The data may be stored as a file in a database of a local workstation, for example for in the context of an internal use. As a variant or in combination, the data may be stored on a remote server comprising or having access to a database, especially via upload over a transmission channel, such as the Internet or an intranet. Said server may be a server of a trusted third party guaranteeing the claimed identity of the user.

The digital sensor may comprise one or more microprocessors or microcontrollers and ancillary circuits, arranged to execute an application intended to transmit the handwritten signatures and the complementary pieces of information to a database for storage and use thereof for the comparison, and to then receive the likelihood score.

Method for Learning Signatures

Another subject of the invention, according to another of its aspects, is a method for learning signatures in order to identify or verify the identity of users, using at least one module to be trained and a plurality of handwritten signatures and of complementary handwritten pieces of information related to the users, the handwritten signatures and the complementary handwritten pieces of information related to the users having been inscribed beforehand on a digital sensor, especially a moveable digital sensor, in which method:

a) at least one signature and at least one complementary piece of information are merged to generate a signature vector, and

b) the module is trained to learn said signature vector.

The features mentioned above with respect to the method of identifying or verifying the identity of a user apply to the method for learning signatures, and vice versa.

Device

Another subject of the invention, according to another of its aspects, is a device for identifying or verifying the identity of a user, using a plurality of previously acquired reference signature vectors, the device being configured to:

a) merge a handwritten signature of the user and at least one complementary handwritten piece of information related to the user, the handwritten signature of the user and the at least one complementary handwritten piece of information related to the user having been inscribed beforehand on a digital sensor, especially a mobile digital sensor, in order to generate at least one test signature vector,

b) comparing said at least one test signature vector to a plurality of said reference signature vectors, and

c) on the basis at least of this comparison, generating a likelihood score in order to identify or verify the identity of the user.

The device according to the invention may comprise or be connected to a database in which the handwritten signatures and the complementary pieces of information are stored, these having been transmitted beforehand by the digital sensor.

The device may comprise a module trained beforehand to learn said plurality of previously acquired reference signature vectors, said module then being trained to compare said test signature vector to a plurality of said reference signature vectors in order to generate the likelihood score.

The trained module may comprise one or more neural networks, and/or one or more decision trees, and/or one or more classifiers.

The device according to the invention may further comprise a storage module configured to store the data in a database of the same computer system and/or of a remote server.

The device may comprise an interface allowing the third party who wishes to identify or verify the identity of the user to choose the one or more complementary pieces of information to be merged with the signatures, the one or more operations used to do this, and the one or more parameters of the trained module or those of the computation of elastic distance for the comparison.

The device is advantageously an electronic system, preferably comprising at least a microcontroller and a memory, and especially a personal computer or a computation server.

The features mentioned above with respect to the methods apply to the device, and vice versa.

Computer Program Product

Another subject of the invention, according to yet another of its aspects, is a computer program product for implementing the method according to the invention for identifying or verifying the identity of a user, the method using a plurality of previously acquired reference signature vectors, a handwritten signature of the user and at least one complementary handwritten piece of information related to the user, the handwritten signature of the user and the at least one complementary handwritten piece of information related to the user having been inscribed beforehand on a digital sensor, especially a moveable digital sensor, the computer program product comprising a medium and, stored on this medium, instructions that are readable by a processor so that, when said instructions are executed:

a) said handwritten signature of the user and said at least one complementary piece of information are merged to generate at least one test signature vector,

b) said at least one test signature vector is compared to a plurality of said reference signature vectors, and

c) on the basis at least of this comparison, a likelihood score is generated in order to identify or verify the identity of the user.

The features mentioned above with respect to the methods and the device apply to the computer program product, and vice versa.

### BRIEF DESCRIPTION OF THE DRAWINGS

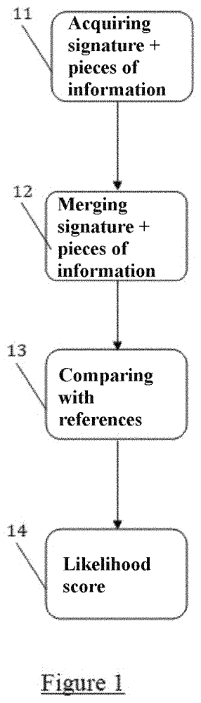

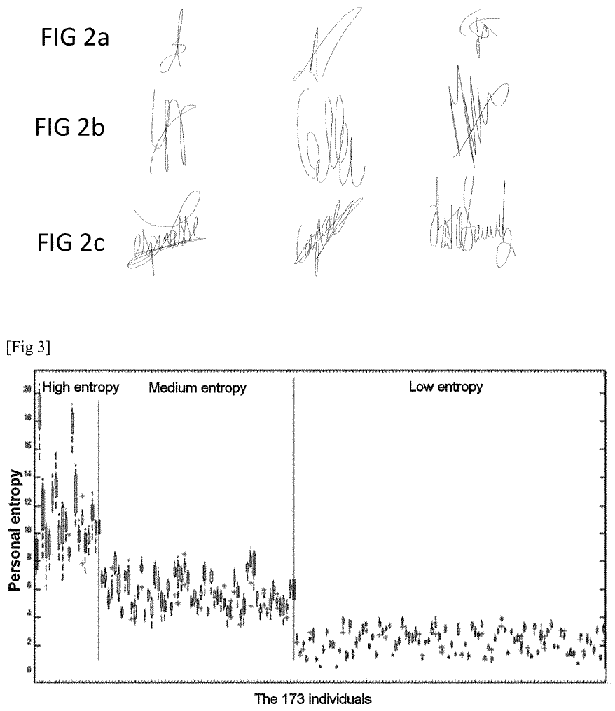

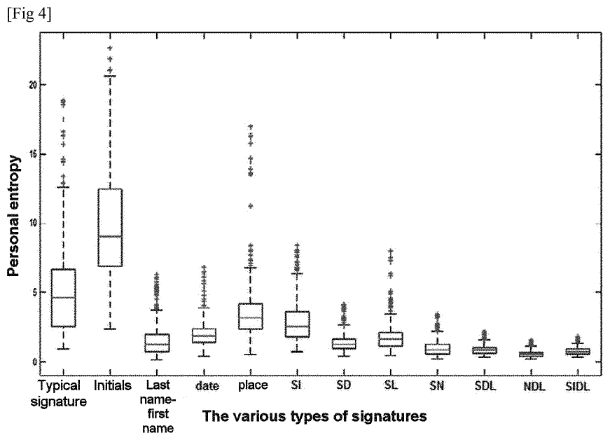

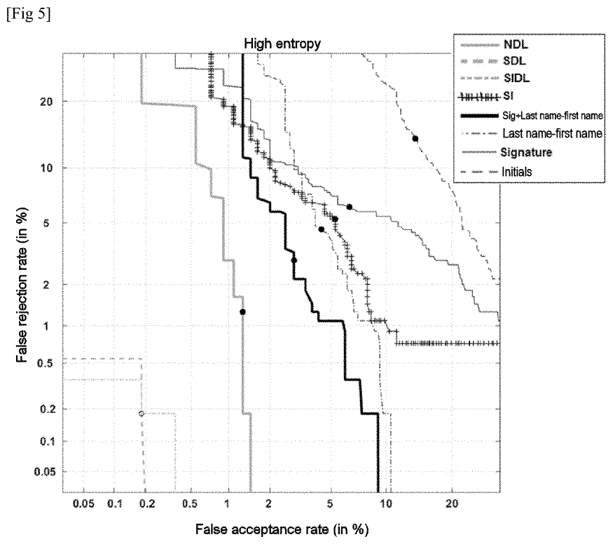

The invention will possibly be better understood on reading the following detailed description, of non-limiting examples of implementation thereof, and on examining the appended drawing, in which:

[FIG. 1] illustrates steps of the identification or verification of the identity of a user according to the invention,

[FIG. 2] shows examples of typical signatures classified into various types,

[FIG. 3] shows quality-measurement values associated with the types of signatures in FIG. 2,

[FIG. 4] shows the distribution of the values of a quality measure for various types of signature vectors, and

[FIG. 5] to [FIG. 7] show performance results of the method according to the invention.

### DETAILED DESCRIPTION

FIG. 1 illustrates an example of steps of the identification or verification of the identity of a user according to the invention, using a plurality of reference signature vectors previously acquired via inscription thereof on a digital sensor. The latter advantageously transmits the handwritten signatures and the complementary pieces of information to a database for them to be stored in order to be used in the method according to the invention, especially using a secure protocol, especially the SFTP protocol.

In this example, in a step 11, a user inscribes, on a digital sensor, his handwritten signature and at least one complementary piece of handwritten information.

In a step 12, said handwritten signature of the user and said at least one complementary piece of information are merged by concatenation to generate a test signature vector.

In a step 13, the test signature vector thus generated is compared to a plurality of said reference signature vectors, and, in a step 14, on the basis at least of this comparison, a likelihood score is generated in order to identify or verify the identity of the user.

As described above, the complementary pieces of information related to the users may be the initials, last name, first name, date of birth, and/or place of birth of the user.

When seeking to identify a user, especially the user of an on-line site, the reference signature vectors correspond to the signatures of various users, these signatures having been inscribed beforehand on a digital sensor and each having been merged with at least one complementary piece of information related to the corresponding user.

When seeking to verify the identity of a user, the reference signature vectors correspond to various signatures inscribed beforehand by said user on a digital sensor, each signature having been merged with at least one complementary piece of information related to the user.

In one embodiment of the invention, a module is trained beforehand to learn said plurality of previously acquired reference signature vectors, said module being then trained to compare said test signature vector to a plurality of said reference signature vectors in order to generate the likelihood score. This trained module may be such as described above.

As a variant, a computation of an elastic distance between the test signature vector and the reference signature vectors is used for their comparison.

Preferably and in the example in question, the likelihood score is compared to one or more predefined thresholds in order to make a decision as to the identity of the user or as to the validity of his identification.

### EXAMPLE 1

### Identity Verification

In a first example, the identity of a user must be ascertained. When enrolling the latter, for example during the creation of his customer account, he is asked to inscribe, on a digital sensor, the following various types of personal information: handwritten signature, initials, last name and first name, date of birth and place of birth.

Reference signature vectors are generated by concatenating the signature with the initials (SI), with the last name-first name (SN), with the date of birth (SD), with the place of birth (SL), with the date and place of birth (SDL), with the initials and date and place of birth (SIDL), and with the last name, first name and date and place of birth (NDL).

A reference identity may thus be formed for the user from these reference signature vectors by learning a statistical model of a module trained beforehand, for example by means of an expectation-maximization algorithm, comprising a number of states that is determined depending on the length of said reference signature vectors, each state being modeled by four Gaussian densities in the example in question.

During the verification, the user inscribes, on a digital sensor, his handwritten signature, and the same complementary pieces of information: initials, last name and first name, date of birth and place of birth, in order to create at least one test signature vector, which is transmitted in a secure way to a server. The module is then trained to compare said test signature vector to the reference identity of the user in order to generate a likelihood score. Depending on the predefined threshold, which in this example is set by a trusted third party, the user's identity is accepted or rejected.

### EXAMPLE 2

### Identification

In a second example, regarding identification of a user on an on-line service or sales site, this user inscribes, on a digital sensor, his handwritten signature and one or more complementary pieces of information, which are then concatenated to create a reference signature vector.

The latter is then compared, according to the invention, with reference signature vectors corresponding to various users and acquired and stored beforehand, in order to verify whether the user is part of the population stored in a database linked to this on-line site.

### EXAMPLE 3

### Validation of the Invention

We will now describe an example of demonstration of the effectiveness of the invention. In this example, 173 individuals inscribed their handwritten signature on a mobile digital sensor, in the present case an iPad tablet, as well as various complementary pieces of information, such as their initials and their first and last name. 74 users among the 173 also inscribed their date and place of birth. To show the reliability achieved via these pieces of information in terms of security and especially of vulnerability to attacks, dynamic signature forgeries were furthermore generated after analyzing the target signatures in terms of course and speed. Such dynamic signature forgeries are considered in the literature to be the strongest type of attack.

A statistical quality measure, personal entropy, was used to measure the quality of the various types of authentic signatures of each individual. The validity of this measurement, which quantifies the complexity and the stability of a signature, has especially been demonstrated in the article by N. Houmani and S. Garcia-Salicetti “Quality criteria for on-line handwritten signature”, in “Signal and Image Processing for Biometrics”, Lecture Notes in Electrical Engineering, Eds: J. Scharcanski, H. Proenca and E. Du; Publisher Springer, 292: 255-283, 2014. An ascending hierarchical classification was applied to the quality measures associated with all of these types of signatures, and their behavior in terms of performance in the resulting categories was analyzed.

An identity verification system such as described in patent application FR 2 893 733 was used to evaluate the effectiveness of the method according to the invention. This system used a statistical HMM trained using normalized reference values, and determined an authentication score.

FIG. 2 shows examples of typical signatures for various categories of personal entropy generated from the database of 173 individuals, and FIG. 3 shows the personal-entropy values associated therewith.

The signatures shown in row (a) of FIG. 2 are considered to have a high personal entropy, i.e. they are rather short and simple (more like initials than a signature in appearance), and are thus very variable, as shown in FIG. 3. These signatures are therefore considered problematic. In contrast, the signatures presented in row (c) of FIG. 2 are considered to have low personal entropy, i.e. they are rather long and complex, sometimes even resembling cursive writing, and are thus considered rather stable, as shown in FIG. 3. Between these two extreme categories, there is a category of transition in terms of complexity and variability: the category with medium personal entropy, as shown in row (b) of FIG. 2 and in FIG. 3. It will be noted that intra-class variability decreases with personal entropy.

For each individual among the 74 individuals who also inscribed their initials, last name, first name, date and place of birth, the personal entropy of the following 5 types of signatures was measured: typical signature, initials, last name-first name, date and place of birth. Furthermore, 7 “hybrid” vectors generated by concatenation were considered: typical signature merged with the initials (SI), with the last name-first name (SN), with the date of birth (SD), with the place of birth (SL), with the date and place of birth (SDL), with the initials and date and place of birth (SIDL), and with the last name, first name and date and place of birth (NDL).

In this case, the personal entropy was based on statistical modeling of a set of vectors, of a single type among the 12 types mentioned above, using a hidden Markov model, trained here on 10 vectors of the same type. The number of states of this model depended on the total length of the vectors, and each state was modeled by 4 Gaussian densities. FIG. 4 shows the distribution of personal-entropy values for each type of vector.

It will be noted that the “initials” type is the one with the highest personal-entropy values, this showing that this type is the simplest and the most variable, this being confirmed in FIG. 4. However, it will also be noted that, in this database of 74 users, some initials have low personal-entropy values, this being explained by the fact that some individuals inscribed 2, 3 or 4 letters by way of initials, sometimes linking them together in the manner of a short signature.

It will be noted that the more the signature is enriched by the concatenation of complementary pieces of information, the more the personal entropy decreases: the complexity of the total information content is thus increased and variability decreased. The hybrid types of vectors SDL, NDL and SIDL are those that show the lowest values of personal entropy, and the lowest variance of the latter between individuals.

For each of the 74 individuals and for each category of personal entropy (low, medium and high) the performance of the identity verification system was evaluated based on signature alone, then on the 7 other types of “hybrid” vectors described above.

FIG. 5 and table 1 show the results for the high-personal-entropy category, corresponding to signatures considered to be problematic.

TABLE 1

| | Typical | | Last name- | Signature + Last | | | | |
|---|---|---|---|---|---|---|---|---|
| Type | signature | Initials | first name | name-first name | SI | NDL | SDL | SIDL |
| EER | 7.17% | 13.83% | 4.33% | 2.67% | 4.83% | 1.17% | 0.17% | 0.17% |

An equal error rate (EER) of 7.17% was obtained considering signatures alone, as may be seen in FIG. 5. A substantial decrease in performance was furthermore observed when individuals sign with their initials, even if their typical signature was already simple. This result thus confirms the vulnerability of initials to attacks, this vulnerability being predictable from the high personal-entropy values in FIG. 4.

In contrast, a significant improvement in performance was observed when the signature was merged with last name and first name, this confirming the robustness to attacks of this type of hybrid vector, as shown in FIG. 4. Including information on date and place of birth clearly improved performance: this type of vector increased performance at the EER by 83.68% compared to the signature alone. The best results were obtained with the SDL and SIDL types: improvement of the order of 97.63% at the EER compared to the signature alone. However, the NDL type had a lower personal entropy than the SDL type, as may be seen in FIG. 4. This reveals that a ballistic gesture, even a simple one, when it is combined with alphanumeric information, such as a date, and handwritten information, such as a place, is much more discriminating than a handwritten gesture combined with the same information, identity-related character being far more present in the ballistic gesture.

Using a vector of SIDL type in, for example, documents of legal importance, would clearly improve the robustness of the authentication compared to the handwritten signature used alone. However, for high-personal-entropy signatures, this type of vector does not achieve much in terms of attack discrimination, compared to the SDL type. This may be explained by the fact that in this particular case, the individuals' high-personal-entropy signature is simple and very variable, and therefore very close to their initials.

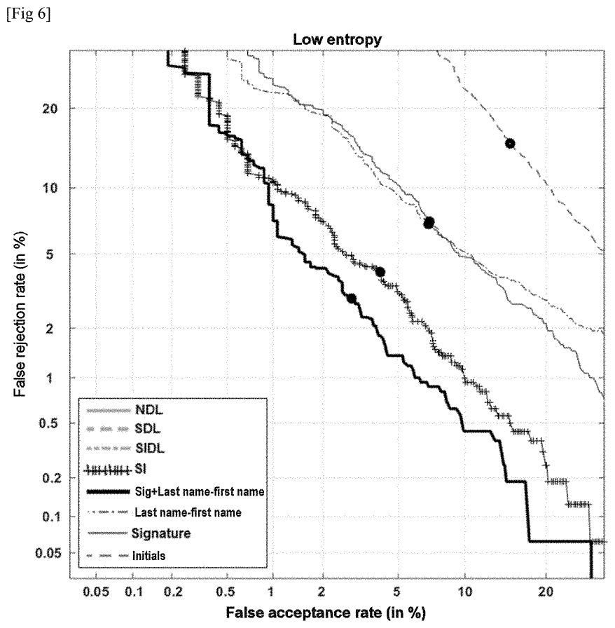

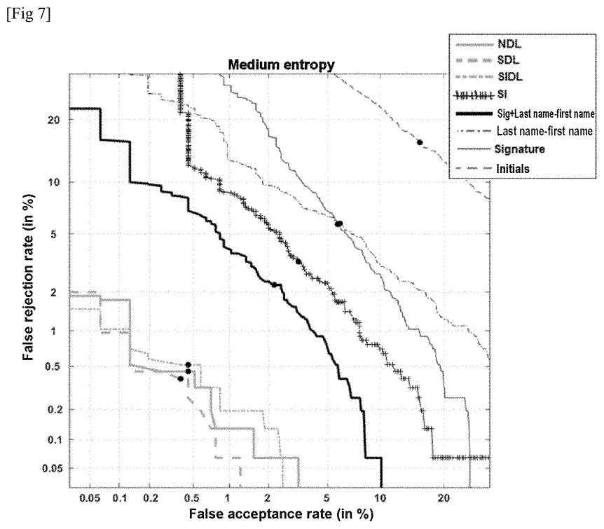

FIG. 6 and table 2 show the results for the low-personal-entropy category, corresponding to the signatures considered to be the most complex and the most stable.

TABLE 2

| | Typical | | Last | Signature + Last | | | | |
|---|---|---|---|---|---|---|---|---|
| Type | signature | Initials | name | name-first name | SI | NDL | SDL | SIDL |
| EER | 6.93% | 15% | 7.07% | 2.91% | 4.06% | 0% | 0% | 0% |

An EER of 6.93% was obtained considering the signatures alone, as may be seen in FIG. 6. The general trend observed in FIG. 4 for the low-personal-entropy category is also confirmed. However, it will be noted that the signature alone gives a performance comparable to that of last name and first name, which is much more complex. This confirms the importance of the ballistic gesture in the verification of identity of individuals, above all when the typical signature is very complex. It will be noted that, for this category of personal entropy, adding the date and place of birth clearly improves performance, with 0% error at the EER. Thus, by virtue of the invention, it is possible to increase the robustness of a signature to attacks, even if it is already robust by virtue of its original properties.

FIG. 7 and table 3 show results for the medium-personal-entropy category.

TABLE 3

| | Typical | | Last name- | Signature + Last | | | | |
|---|---|---|---|---|---|---|---|---|
| Type | signature | Initials | first name | name-first name | SI | NDL | SDL | SIDL |
| EER | 5.93% | 16.07% | 5.97% | 2.3% | 3.33% | 0.47% | 0.4% | 0.5% |

The results for this category confirm those already announced above. It will be noted that, for this category, the SDL type is the one that provides the best performance. This result is close to that obtained with the high-personal-entropy category.

The invention thus allows a good performance to be achieved under mobile and uncontrolled conditions, it providing error rates comparable to those obtained on graphics tablets under controlled conditions.

Of course, the invention is not limited to the examples that have just been described. In particular, any other type of complementary pieces of information related to users, merging and comparing methods, and learning and training models may be used.

### Applications of the Invention

The invention is aimed at applications in which digital identity is tested.

The method according to the invention may be used in on-line commerce and sales, especially in order to reinforce a password with an on-line signature when creating a customer account with a commerce site. Any order may subsequently be validated with the handwritten signature on-line to ensure the identity of the customer.

The invention could also be of interest to public services, especially in respect of tax declarations, the payment of fines, on-line health-insurance accounts (e.g. Ameli in France), the issuance of driving licenses, on-line pension accounts and TFSAs, and of the services of the post office, such as redirection or on-line parcel tracking. Most of these services are already available on-line, especially through the Internet site “FranceConnect” in France, and thus need to be highly secure.

The invention may be used in the context of legal and notarial services, especially to sign digital documents.

Banking applications could use the methods according to the invention, especially to sign on-line or dematerialized contracts. The invention may also be used in the context of payment of bills on-line, for example for electricity, gas, school canteens or extracurricular activities.

In the field of collection and/or delivery of letters and parcels, operators such as La Poste, DHL, UPS, Fedex, etc., already use digital platforms to acquire a handwritten signature on-line during deliveries. Automatic identity verification could be implemented by virtue of the invention.

The invention may be used in the context of parental control on platforms connected to the Internet at home or at school.

The contribution of the invention is all the greater given that more and more applications deployed on a large-scale require user enrolment to be carried out remotely and/or under uncontrolled mobile conditions.

1. A method for identifying or verifying the identity of a user, using a plurality of previously acquired reference signature vectors, a handwritten signature of the user and at least one complementary handwritten piece of information related to the user, the handwritten signature of the user and the at least one complementary handwritten piece of information related to the user having been inscribed beforehand on a digital sensor, especially a mobile digital sensor, in which method:
a) said handwritten signature of the user and said at least one complementary piece of information are merged to generate at least one test signature vector,
b) said at least one test signature vector is compared to a plurality of said reference signature vectors, and
c) on the basis at least of this comparison, a likelihood score is generated in order to identify or verify the identity of the user.

2. The method as claimed in claim 1, wherein, a module being trained beforehand to learn said plurality of previously acquired reference signature vectors, said module is then trained to compare said test signature vector to a plurality of said reference signature vectors in order to generate the likelihood score.

3. The method as claimed in claim 1, wherein the complementary pieces of information related to the user are the initials, last name, first name, date of birth, and/or place of birth of the user.

4. The method as claimed in claim 1, wherein, when seeking to identify a user, especially the user of an on-line service or sales site, the reference signature vectors correspond to the signatures of various users, these signatures having been inscribed beforehand on a digital sensor and each having been merged with at least one complementary piece of information related to the corresponding user.

5. The method as claimed in claim 1, wherein, when seeking to verify the identity of a user, the reference signature vectors correspond to various signatures inscribed beforehand by said user on a digital sensor, each signature having been merged with at least one complementary piece of information related to the user.

6. The method as claimed in claim 2, wherein a reference identity is formed for the user from the reference signature vectors by learning a statistical model, especially by means of an expectation-maximization algorithm, especially comprising a number of states that is determined depending on the length of said reference signature vectors, each state especially being modeled by one or more Gaussian densities, and preferably by four Gaussian densities.

7. The method as claimed in claim 6, wherein a handwritten signature of the user and at least one complementary piece of information are merged to generate a test signature vector, which is transmitted to the trained module to be compared with the reference identity of said user in order to generate a likelihood score of the identity of the user.

8. The method as claimed in claim 2, wherein the trained module uses a hidden Markov model.

9. The method as claimed in claim 2, wherein the trained module comprises one or more neural networks, and/or one or more decision trees, and/or one or more classifiers.

10. The method as claimed in claim 1, wherein a computation of an elastic distance between the test signature vector and the reference signature vectors is used for their comparison.

11. The method as claimed in claim 1, wherein the same type of complementary information is used to generate the reference signature vectors of a given user.

12. The method as claimed in claim 1, wherein the handwritten signatures are merged with the complementary pieces of information by concatenation to generate the signature vectors.

13. The method as claimed in claim 1, wherein the signature vectors correspond to handwritten signatures of a user merged with his initials, and/or with his last name and first name, and/or with his date of birth, and/or with his place of birth.

14. The method as claimed in claim 1, in which the likelihood score takes the form of a probability, or of a numerical value, especially a discrete value, or of a letter.

15. The method as claimed in claim 1, wherein the likelihood score is compared to one or more predefined thresholds in order to make a decision as to the identity of the user or as to the validity of his identification.

16. The method as claimed in claim 1, wherein the digital sensor transmits the handwritten signatures and the complementary pieces of information to a database for them to be stored in order to be used for the comparison, especially using a secure protocol, especially the SFTP protocol.

17. A method for learning signatures in order to identify or verify the identity of users, using at least one module to be trained and a plurality of handwritten signatures and of complementary handwritten pieces of information related to the users, the handwritten signatures and the complementary handwritten pieces of information related to the users having been inscribed beforehand on a digital sensor, especially a moveable digital sensor, in which method:
a) at least one signature and at least one complementary piece of information are merged to generate a signature vector, and
b) the module is trained to learn said signature vector.

18. A device for identifying or verifying the identity of a user, using a plurality of previously acquired reference signature vectors, the device being configured to:
a) merge a handwritten signature of the user and at least one complementary handwritten piece of information related to the user, the handwritten signature of the user and the at least one complementary handwritten piece of information related to the user having been inscribed beforehand on a digital sensor, especially a mobile digital sensor, in order to generate at least one test signature vector,
b) comparing said at least one test signature vector to a plurality of said reference signature vectors, and
c) on the basis at least of this comparison, generating a likelihood score in order to identify or verify the identity of the user.

19. The device as claimed in claim 18, comprising or being connected to a database in which the handwritten signatures and the complementary pieces of information are stored, these having been transmitted beforehand by the digital sensor.

20. The device as claimed in claim 18, comprising a module trained beforehand to learn said plurality of previously acquired reference signature vectors, said module then being trained to compare said test signature vector to a plurality of said reference signature vectors in order to generate the likelihood score.

21. A computer program product for implementing the method for identifying or verifying the identity of a user as claimed in claim 1, the method using a plurality of previously acquired reference signature vectors, a handwritten signature of the user and at least one complementary handwritten piece of information related to the user, the handwritten signature of the user and the at least one complementary handwritten piece of information related to the user having been inscribed beforehand on a digital sensor, especially a moveable digital sensor, the computer program product comprising a medium and, stored on this medium, instructions that are readable by a processor so that, when said instructions are executed:
a) said handwritten signature of the user and said at least one complementary piece of information are merged to generate at least one test signature vector,
b) said at least one test signature vector is compared to a plurality of said reference signature vectors, and
c) on the basis at least of this comparison, a likelihood score is generated in order to identify or verify the identity of the user.
